(19) United States
(12) Patent Application Publication
(10) Pub. No.: US 2024/0220704 A1
(43) Pub. Date: Jul. 4, 2024

(54) METHOD, APPARATUS, DEVICE AND STORAGE MEDIUM FOR DISPLAYING REVIEW INFORMATION

(71) Applicant: Beijing Zitiao Network Technology Co., Ltd., Haidian District, Beijing (CN)

(72) Inventors: Guoyao Yan, Beijing (CN); Yutong Jin, Beijing (CN); Junlin Wen, Beijing (CN); Mengfei Han, Beijing (CN)

(21) Appl. No.: 18/564,561

(22) PCT Filed: Aug. 23, 2022
(86) PCT No.: PCT/CN2022/114131

§ 371 Date: Nov. 27, 2023

(30) Foreign Application Priority Data
Sep. 24, 2021 (CN) 202111124159.0

(51) Int. Cl. G06F 40/106; G06F 3/0481; G06F 40/109; G06F 40/166

(52) U.S. Cl. CPC G06F 40/106; G06F 3/0481; G06F 40/109; G06F 40/166

(57) ABSTRACT

The disclosure relates to a method, apparatus, device, and storage medium for displaying review information. The method herein-includes: displaying to-be-modified text segments of a reviewed text in a first display style in a review result page, and displaying text segments of the reviewed text other than the to-be-modified text segments in a second display style(S; and in response to a first trigger operation on a to-be-modified target text segment of the respective to-be-modified text segments, displaying a target issue introduction and a target review basis corresponding to the to-be-modified target text segment in a predetermined display mode in the review result page. A user is enabled to know issues existing in the to-be-modified target text segments and their corresponding modification suggestions quickly and clearly, improving the amount and transparency of information displayed by review results, and then improving modification efficiency and modification approval rate of the to-be-modified text segments.

### CROSS REFERENCE TO RELATED APPLICATIONS

The present application claims priority to Chinese Patent Application No. 202111124159.0, filed on Sep. 24, 2021 and entitled “METHOD, APPARATUS, DEVICE AND STORAGE MEDIUM FOR DISPLAYING REVIEW INFORMATION”, the contents of which are hereby incorporated by reference in its entirely.

### FIELD

The present disclosure relates to the field of information display technologies, and in particular to a method, apparatus, device, and storage medium for displaying review information.

### BACKGROUND

With the popularity of electronic devices in daily life, more and more information (such as coverage, novels, documents, articles, etc.) is published and read in electronic form. When a user of a certain text-based information publishes the text-based information through an electronic device, the backend needs to review it based on corresponding rules (such as cyber security rules, plagiarism detection rate rules, etc.). Only content that has been approved can be published to the network. For content that has been reviewed and disapproved, the backend will provide the user with a review result that the content is reviewed and disapproved, which will include prompt information about the content that has not been approved.

Currently, the display of the review result often highlights the content that has not been approved in the text-based information, with a brief prompt of a general reason for the disapproved review. However, this way of displaying the review result cannot give users a clear understanding of modification, making it difficult for users to accurately understand the content to be modified and its modification requirements, resulting in lower modification efficiency and an approval rate.

### SUMMARY

In order to solve the above technical problems or at least partially solve the above technical problems, the present disclosure provides a method, apparatus, device, and storage medium for displaying review information.

In a first aspect, the present disclosure provides a method for displaying review information, which includes:
displaying to-be-modified text segments of a reviewed text in a first display style in a review result page, and displaying text segments of the reviewed text other than the to-be-modified text segments in a second display style; and
in response to a first trigger operation on a to-be-modified target text segment of the respective to-be-modified text segments, displaying a target issue introduction and a target review basis corresponding to the to-be-modified target text segment in a predetermined display mode in the review result page.

In a second aspect, the present disclosure provides an apparatus for displaying review information, which includes:
a first information display module configured to display to-be-modified text segments of a reviewed text in a first display style in a review result page, and displaying text segments of the reviewed text other than the to-be-modified text segments in a second display style; and
a second information display module configured to display, in response to a first trigger operation on a to-be-modified target text segment of the respective to-be-modified text segments, a target issue introduction and a target review basis corresponding to the to-be-modified target text segment in a predetermined display mode in the review result page.

In a third aspect, the present disclosure provides a device for displaying review information, which includes:
a processor; and
a memory for storing executable instructions;
wherein the processor is configured to read the executable instructions from the memory and execute the executable instructions to implement the method for displaying review information according to any embodiment of the present disclosure.
   In a fourth aspect, the present disclosure provides a computer-readable storage medium, characterized in that the storage medium stores a computer program which, when executed by a processor, causes the processor to implement the method for displaying review information according to any embodiment of the present disclosure.

The method, apparatus, device, and storage medium for displaying review information in the embodiments the present disclosure can display to-be-modified text segments of a reviewed text in a first display style in a review result page, and display text segments of the reviewed text other than the to-be-modified text segments in a second display style. The to-be-modified text segments can be highlighted thereby, so that a user can view text content that has not been approved more quickly. And in response to a first trigger operation on a to-be-modified target text segment of the respective to-be-modified text segments, a target issue introduction and a target review basis corresponding to the to-be-modified target text segment are displayed in a predetermined display mode in the review result page, so that the position of the to-be-modified target text segment triggered by the user is determined quickly. At the same time, the target issue introduction and its corresponding target review basis of the to-be-modified target text segment that has not been approved are displayed in detail, so that the user can quickly and clearly know the issues existing in the to-be-modified target text segment and the corresponding modification suggestions, improving the amount and transparency of information displayed in the review result, thereby improving modification efficiency and modification approval rate of the to-be-modified text segments.

### BRIEF DESCRIPTION OF DRAWINGS

In conjunction with the accompanying drawings and with reference to the following detailed description, the above and other features, advantages and aspects of the various embodiments of the present disclosure will become more apparent. Throughout the drawings, like or similar reference numbers denote like or similar elements. It should be understood that the drawings are illustrative and that the components and elements are not necessarily drawn to scale.

FIG. 1 is a schematic flow chart of a method for displaying review information provided in an embodiment of the present disclosure;

FIG. 2 is a schematic diagram of display effect of a review result page provided in an embodiment of the present disclosure;

FIG. 3 is a schematic diagram of display effect of another review result page provided in an embodiment of the present disclosure;

FIG. 4 is a schematic diagram of display effect of a further review result page provided in an embodiment of the present disclosure;

FIG. 5 is a schematic diagram of display effect of a further review result page provided in an embodiment of the present disclosure;

FIG. 6 is a schematic diagram of display effect of a further review result page provided in an embodiment of the present disclosure;

FIG. 7 is a schematic diagram of display effect of a further review result page provided in an embodiment of the present disclosure;

FIG. 8 is a schematic diagram of display effect of a further review result page provided in an embodiment of the present disclosure;

FIG. 9 is a schematic diagram of display effect of a further review result page provided in an embodiment of the present disclosure;

FIG. 10 is a schematic diagram of display effect of a further review result page provided in an embodiment of the present disclosure;

FIG. 11 is a schematic diagram of display effect of a further review result page provided in an embodiment of the present disclosure;

FIG. 12 is a schematic diagram of a structure of an apparatus for displaying review information provided in an embodiment of the present disclosure; and

FIG. 13 is a schematic diagram of a structure of a device for displaying review information provided by the present disclosure.

### DETAILED DESCRIPTION

The following embodiments of the present disclosure will be described in more detail with reference to the accompanying drawings. Although certain embodiments of the present disclosure are shown in the drawings, it should be understood that the present disclosure can be implemented in various forms and should not be construed as limited to the embodiments predetermined forth herein. On the contrary, these embodiments are provided for a more thorough and complete understanding of the present disclosure. It should be understood that the drawings and embodiments of the present disclosure are for illustrative purposes only and are not intended to limit the scope of the present disclosure.

It should be understood that the various steps described in the method implementation method of the present disclosure can be executed in different orders and/or in parallel. In addition, the method implementation can include additional steps and/or omit the steps shown. The scope of the present disclosure is not limited in this regard.

The term “including” and its variations used in this article are openly inclusive, i.e. “including but not limited to”. The term “based on” means “at least partially based on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that the concepts of “first” and “second” mentioned in the present disclosure are only used to distinguish different apparatuses, modules, or units, and are not used to limit the order or interdependence of the functions performed by these apparatuses, modules, or units.

It should be noted that the modifications of “one” and “a plurality of” mentioned in the present disclosure are illustrative and not restrictive. Those skilled in the art should understand that unless otherwise specified in the context, they should be understood as “one or more”.

The names of the messages or information exchanged between a plurality of apparatuses in an implementation of the present disclosure are for illustrative purposes only and are not intended to limit the scope of these messages or information.

Currently, a method for displaying a review result of electronic content often highlights the content reviewed and disapproved (i.e. the to-be-modified text segments), and to prompt the general reason for the review and disapproved content, such as to prompt the categories of the review rules (i.e. the review basis) corresponding to the to-be-modified text segments. However, this method for displaying a review result can only provide users with the most basic information about the review failure, and cannot make the users clearly understand an issue of each to-be-modified text segment, nor can it enable the users to know how to make more appropriate modifications to quickly be approved.

Based on the above situation, the embodiments of the present application provide a review information display scheme to realize that after the completion of a publish review of text-based content, to-be-modified text segments which have been disapproved in the review are highlighted, and a corresponding target issue introduction is displayed when a user triggers the to-be-modified target text segments, so that the user can quickly and clearly understand the issues causing the review to fail that exists. At the same time, a target review basis of a to-be-modified target text segment is displayed, so that the user can understand in detail the review basis that the to-be-modified target text segment violates, thereby prompting the user to modify the to-be-modified target text segment based on the target review basis, improving efficiency and an approval rate of modifying the to-be-modified text segment.

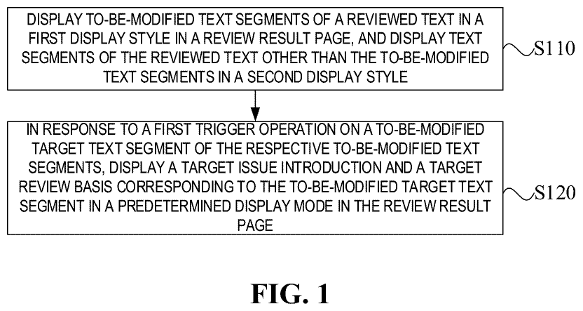

Firstly, a method for displaying review information provided in embodiments of the present disclosure will be illustrated below in conjunction with FIGS. 1-11.

In embodiments of the present disclosure, the method for displaying review information may be performed by an apparatus for displaying review information, which may be implemented by software and/or hardware or may be integrated in a device for displaying review information. The device for displaying review information herein may include but is not limited to mobile terminals such as smartphones, laptops, PDAs (personal digital assistants), PAD (tablet computers), PMPs (portable multimedia players), vehicle-mounted terminals (such as car navigation terminals), wearable devices, and fixed terminals such as digital TVs and desktop computers.

FIG. 1 shows a schematic flow chart of a method for displaying review information provided in an embodiment of the present disclosure. As shown in FIG. 1, the method for displaying review information may include the following steps:

S110: displaying to-be-modified text segments of a reviewed text in a first display style in a review result page, and displaying text segments of the reviewed text other than the to-be-modified text segments in a second display style.

The first display style and the second display style are both predetermined text display styles. Moreover, the first display style and the second display style are different. The display styles herein can include at least one of text base color, text color, font size, font, bold, italic, etc. The reviewed text refers to a text that has been subject to a publish review by a review server side, which can be a text uploaded by a user, or a text obtained by performing image processing operations, such as image correction, text recognition, noise filtering etc., on the image uploaded by the user. The to-be-modified text segments refer to text segments that are not approved in the reviewed text.

Specifically, the user sends the information that he/she wants to publish to the network to the review server side. The review server side reviews whether it complies with publishing rules (also known as the review basis, such as cyber security rules, sentence smoothness rules, etc.) to obtain a review result, and feeds back the review result to a device for displaying review information. A review result page is displayed to the user by the device for displaying review information. The review result page displays the reviewed text, and displays the respective to-be-modified text segments of the reviewed text in the first display style, while displaying text segments of the reviewed text other than the respective to-be-modified text segments in the second display style.

For example, the second display style is a default text display style, and the first display style highlights the text (the text base color is a color with higher brightness) on the basis of the second display style. Therefore, the reviewed text is displayed in the default text display style in the review result page, and on this basis, the respective to-be-modified text segments of the reviewed text are highlighted. By doing so, it is possible to a achieve display effect that the respective to-be-modified text segments are highlighted to make the to-be-modified text segments more eye-catching, thereby clearly prompting the users the text segments with review issues.

The review result page can be automatically triggered and displayed after the device for displaying review information receives the review result. The review result page can also be a prompt message displayed after the device for displaying review information receives the review result, the prompt message indicating that the review is disapproved. The user triggers the display after triggering the control corresponding to the prompt message. For example, the device for displaying review information displays a chapter title of a novel or article, and attaches relevant information about the disapproval after the chapter title that has be disapproved in the review. The user triggers the review result page corresponding to the chapter title to be display by clicking on the chapter title of the attached information or its corresponding editing control. The above triggering operation can be a click operation, voice control operation, gesture control operation or eye movement control operation, etc.

In some embodiments, issue types corresponding to the respective to-be-modified text segments and the number of issues for each of the issue types are displayed in the review result page additionally.

The issue types herein refers to the types of reasons why the text segments is not approved in the review, or the types of issues that cause the text segments to be approved in the review. In some embodiments, the issue types comprise a typo issue and a violation issue that violates a review basis. Moreover, a priority of the violation issue is higher than that of the typo issue. That is, when there are two types of issues in a certain to-be-modified text segment at the same time, the detailed information corresponding to the violation issue should be displayed first, and the typo issue or other prompt information should be displayed only after the violation issue is corrected. This can encourage users to modify the to-be-modified text segments with more serious issues first.

Specifically, there are some to-be-modified text segments with a small number of words in all to-be-modified text segments, such as one or two typos, short sentences with unclear sentences, sensitive vocabulary, etc. These to-be-modified text segments with a small number of words are easily drowned out in the long-format reviewed text and ignored by users. Based on this, the issue types to which the respective to-be-modified text segment belongs, as well as the number of the to-be-modified text segments belong to each issue type, that is, the number of issues can be displayed in the review result page additionally. By doing this, it is possible to globally prompt unapproved issues in the reviewed text, avoiding the user missing the viewing and modification of some to-be-modified text segments, further improving the amount of information displayed in the review result, and thereby further improving the modification efficiency and the approval rate of the to-be-modified text segments.

For example, there are a total of 22 to-be-modified text segments in the reviewed text. Among these to-be-modified text segments, the number of to-be-modified text segments belonging to the typo issue is 12, and the number of to-be-modified text segments belonging to a violation issue is 10. Therefore, the typo issue and its corresponding number of issues 12 can be displayed at the review result page, and the violation issue and its corresponding number of issues 10 can also be displayed. The display positions and display styles of the issue types and its corresponding numbers of issues are not limited, and only need to be able to make the user pay attention to the.

It should be noted that when a user corrects the to-be-modified text segments corresponding to a certain issue type, the number of issues corresponding to that issue type should be reduced by 1 to maintain consistency between the number of to-be-modified text segments and the number of issues corresponding to each issue type.

S120: in response to a first trigger operation on a to-be-modified target text segment of the respective to-be-modified text segments, displaying a target issue introduction and a target review basis corresponding to the to-be-modified target text segment in a predetermined display mode in the review result page.

The predetermined display mode herein is a predetermined display mode, which can include a display position and/or a display style. The issue summary refers to a brief introduction to the issues existing in the to-be-modified text segment, such as an overview of the review basis it violates, or the title of the publishing rule corresponding to the review basis it violates.

Specifically, the user can interact with the respective highlighted to-be-modified text segments in the review result page. If the user wants to view the detailed review result of a certain to-be-modified text segment (i.e. the to-be-modified target text segment), he/she can perform a trigger operation(i.e. the first trigger operation) on the to-be-modified target text segment. The mapping relationship between the to-be-modified text segments and their corresponding issue introductions and review bases is pre-established in the device for displaying review information. In this way, when the device for displaying review information detects the first trigger operation, it can query the mapping relationship based on the to-be-modified target text segment, and obtain a issue introduction (i.e. the target issue introduction) and a review basis (i.e. the target review basis) corresponding to the to-be-modified target text segment. Then, the target issue introduction and the target review basis are displayed in a predetermined display mode in the review result page.

For example, the predetermined display mode includes the display position, which can be a pop-up window. After the user triggers the to-be-modified target text segment in the review result page, a pop-up window will be displayed around it, and the target issue introduction and the target review basis will be displayed in the pop-up window.

For another example, the predetermined display mode includes the display position, which can be a fixed area with a smaller area in the review result page. After the user triggers the to-be-modified target text segment in the review result page, the target issue introduction and target review basis will be displayed in the fixed area in the review result page.

For a further example, the predetermined display mode includes the display position and the display style. The display position can be a fixed area with a larger area in the review result page. The fixed area with a larger area displays the issue introductions and review bases corresponding to the respective to-be-modified text segments. The display style can be emphasized style relative to the default display style, such as highlight display style, bold display style, etc. After the user triggers the to-be-modified target text segment in the review result page, the target issue introduction and target review basis will be emphasized in the fixed area in the review result page.

In some embodiments, in order to further improve the amount of information that can be displayed in the review result page, the embodiments of the present disclosure provide review bases designed in a multi-level manner, that is, review bases comprise a review basis of a highest level, a review basis of a middle level, and a review basis of a lowest level. There is at least one review basis of the middle level under the review basis of the highest level, and there is at least one review basis of the lowest level under each review basis of the middle level. The review basis of the highest level is the most general and abstract review basis; content of the review basis of the middle level is more detailed than that of the review basis of the highest level, but less detailed than that of the review basis of the lowest level; and the content of the review basis of the lowest level is the most detailed.

On the basis of the above embodiment, in order to enable users to view the review basis of which the content is the most detailed first, the review basis displayed directly in response to the user triggers the to-be-modified text segment is determined as the review basis of the lowest level. That is, the target review basis is the review basis of the lowest level corresponding to the to-be-modified target text segment.

On the basis of the above embodiment, a multi-level viewing interactive function for review basis is provided, so that the user can view different levels of review basis according to their needs. That is, after the target issue introduction and target review basis corresponding to the to-be-modified target text segment are displayed in a predetermined display mode in the review result page, in response to a second trigger operation of a user, the review basis of the middle level and/or the review basis of the highest level corresponding to the target review basis are displayed in the review result page.

Specifically, after displaying the target review basis, a control for viewing more review basis can be displayed in the surrounding area of the target review basis, such as a control for viewing the middle level, a control for viewing the highest level, etc. Users can trigger the controls to request viewing of the review basis of other level. At this time, the device for displaying review information can detect a trigger operation of the user on the control (i.e., the second trigger operation). Then, the review basis of the middle level and/or the review basis of the highest level corresponding to the target review basis are displayed in the display position of the target review basis in the review result page; or, the corresponding the review basis of the middle level and/or the review basis of the highest level continues to be displayed in the surrounding area of the display position of the target review basis in the review result page.

The method for displaying review information provided in the various embodiments described above can display to-be-modified text segments of a reviewed text in a first display style in a review result page, and display text segments of the reviewed text other than the to-be-modified text segments in a second display style. The to-be-modified text segments can be highlighted thereby, so that a user can view text content that has not been approved more quickly. And in response to a first trigger operation on a to-be-modified target text segment of the respective to-be-modified text segments, a target issue introduction and a target review basis corresponding to the to-be-modified target text segment are displayed in a predetermined display mode in the review result page, so that the position of the to-be-modified target text segment triggered by the user is determined quickly. At the same time, the target issue introduction and its corresponding target review basis of the to-be-modified target text segment that has not been approved are displayed in detail, so that the user can quickly and clearly know the issues existing in the to-be-modified target text segment and the corresponding modification suggestions, improving the amount and transparency of information displayed in the review result, thereby improving modification efficiency and modification approval rate of the to-be-modified text segments.

In one embodiment provided in the present disclosure, in accordance with a determination that the method for displaying review information may be implemented at a mobile client, the method for displaying review information is applied to a mobile terminal, such as a smart phone, a PDA, a smart wearable device.

In some embodiments, displaying a target issue introduction and a target review basis corresponding to the to-be-modified target text segment in a predetermined display mode in the review result page in the above-described S120 comprises creating a pop-up window in the review result page, and displaying the target issue introduction and the target review basis in the pop-up window.

Specifically, based on the fact that a display screen of a mobile terminal is relatively small, the target issue introduction and target review basis can be displayed through the pop-up window. The size of the pop-up window can be fixed or adjusted to a certain extent based on the amount of displayed content. When the complete content cannot be displayed in the pop-up window, a scrolling function or page jump function can be set for it. The display position of the pop-up window is in the surrounding area of the to-be-modified target text segment, so that users can understand that the content displayed in the pop-up window corresponds to the to-be-modified target text segment. When the user triggers the area outside the pop-up window (or the closing control of the pop-up window), the pop-up window is hidden. By the setting of the pop-up window, the target issue introduction and target review basis can be displayed nearby, which is not only convenient for users to view correspondingly, but also enables to view corresponding issue introductions and review basis triggers of the to-be-modified text segments immediately at any time it is triggered, which is more flexible and improves viewing efficiency of detailed review results.

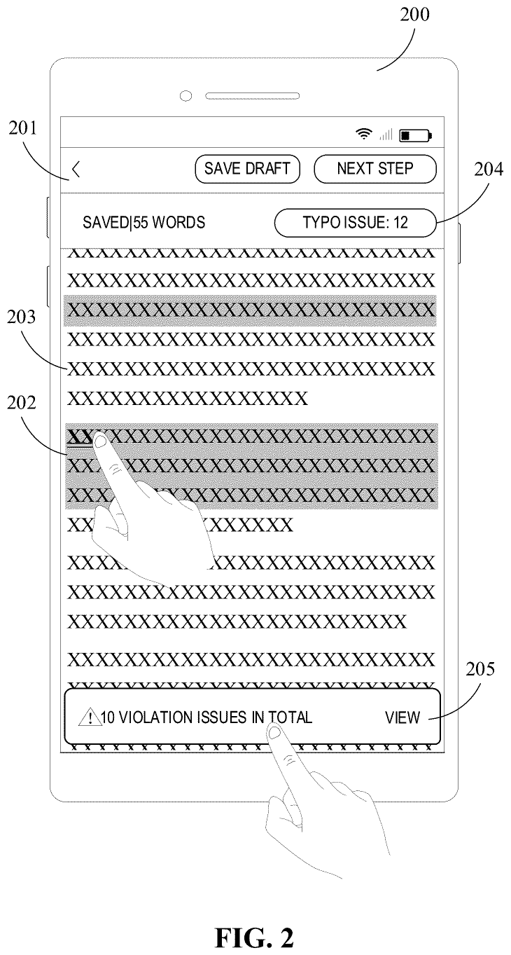

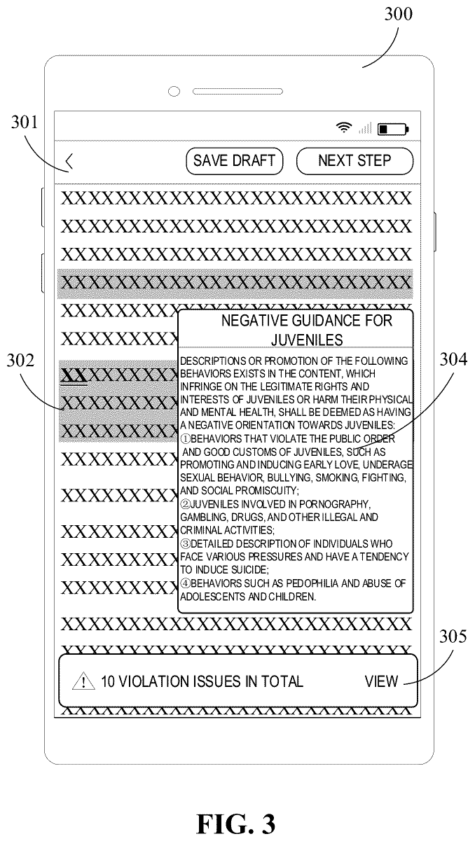

FIG. 2 is a schematic diagram of display effect of a review result page provided in an embodiment of the present disclosure. Referring to FIG. 2, a device 200 for displaying review information displays a review result page 201. The review result page 201 displays a control “Save Draft” that saves modification traces and a control “Next Step” that completes modification. A to-be-modified text segments 202 and another text segment 203 of the reviewed text other than the to-be-modified text segments are displayed additionally in the review result page 201. The other text segment 203 is displayed in a second display style (shown in black text in FIG. 2), and the to-be-modified text segment 202 is displayed in a first display style (shown in gray shading, bold, and underline examples in FIG. 2) different from the second display style. When a user triggers a certain to-be-modified text segment 202, a pop-up window is displayed in the review result page 201, and the display effect is shown in FIG. 3.

As shown in FIG. 3, a device 300 for displaying review information displays a review result page 301, and a pop-up window 304 is displayed around a to-be-modified target text segment 302 in the review result page 301. The pop-up window 304 displays a target issue introduction “Negative Guidance for Juveniles” and a target review basis “Descriptions or promotion of the following behaviors exists in the content . . . ”.

For a case where the target review basis shown in FIG. 3 has a large amount of content, a view control for viewing a review basis can also be displayed. After the user triggers the view control, the target issue introduction and target review basis are displayed in the pop-up window.

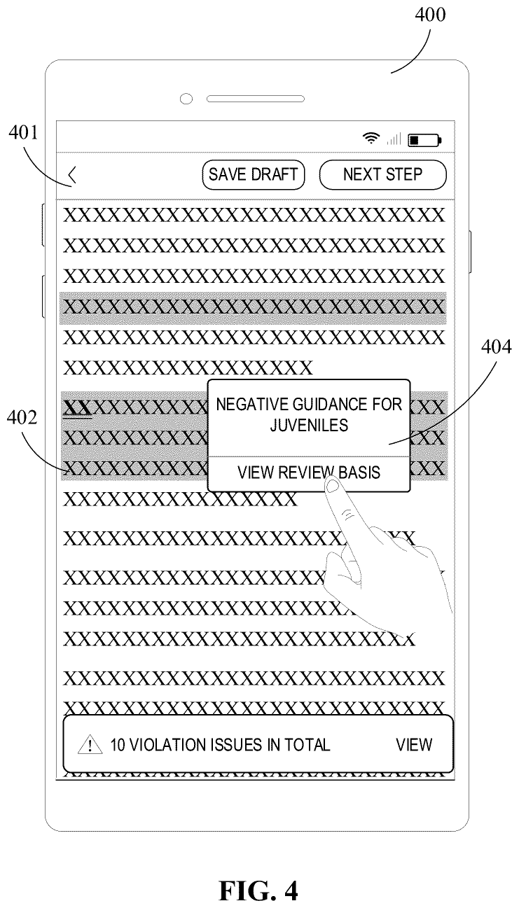

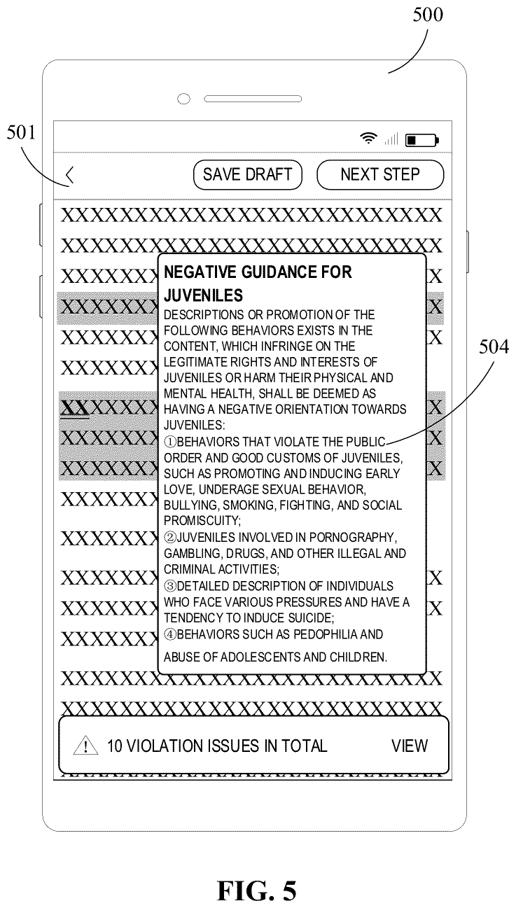

As shown in FIG. 4, a device 400 for displaying review information displays a review result page 401. When a user triggers the to-be-modified target text segment 202 in FIG. 2, the review result page 401 in FIG. 4 will display a pop-up window 404 corresponding to a to-be-modified target text segment 402. The pop-up window 404 displays a target issue introduction “Negative Guidance for Juveniles” and a “View Review Basis” control corresponding to the target review basis. When the user triggers the “View Review Basis” control, a pop-up window 504 in a review result page 501 of a device 500 for displaying review information in FIG. 5 is displayed. The pop-up window 504 displays the target issue introduction “Negative Guidance for Juveniles” and the target review basis “Descriptions or promotion of the following behaviors exists in the content . . . ”

It should be noted that in accordance with a determination that a display position of the pop-up window at least partially overlaps with a display position of a text input window, the display position of the pop-up window can be moved until there is no overlap between the display position of the pop-up window and the display position of the text input window. That is, after the pop-up window is displayed, if the user triggers an input operation to modify the to-be-modified text segment by inputting text, the text input window (such as an electronic keyboard) will pop up in the review result page. When the text input window and the pop-up window are displayed at the same time, they should not overlap with each other. If there is a conflict between the display position of the text input window and the display position of the pop-up window, the display position of the pop-up window is adjusted until both can be fully displayed.

In other embodiments, the displaying a target issue introduction and a target review basis corresponding to the to-be-modified target text segment in a predetermined display mode in the review result page in the above-described S120 comprises displaying the target issue introduction and the target review basis in a first predetermined area of the review result page.

Specifically, based on the fact that a display screen of a mobile terminal is relatively small, a fixed area with a small area (i.e., the first predetermined area) can be selected in the review information display page, and a panel-type control is provided in the first predetermined area to display detailed review results, i.e., the target issue introduction and the target review basis.

The same as the above explanation regarding the pop-up window, because the area of the fixed area is small, it may not be able to display the complete review basis. In this embodiment, a view control corresponding to the review basis is provided, and a pop-up window is designed for the view control to display a detailed review basis. By providing the fixed area, it is possible to display issue introductions and review bases corresponding to different to-be-modified text segments in the same area, and also enable the user to clearly view the detailed review result.

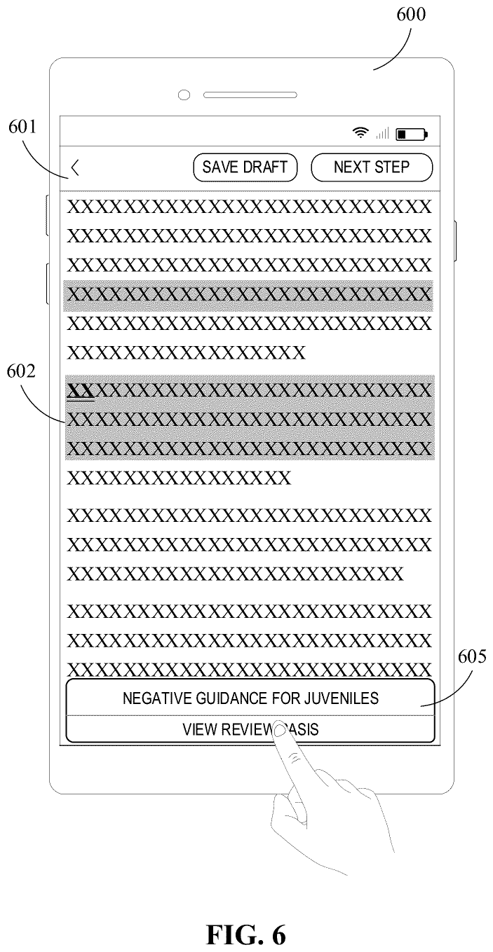

As shown in FIG. 2, when the user triggers the to-be-modified target text segment 202 in FIG. 2, a first predetermined area 605 in a review result page 601 in FIG. 6 will display a target issue introduction “Negative Guidance for Juveniles” corresponding to a to-be-modified target text segment 602 and a “View Review Basis” control corresponding to a target review basis. When the user triggers the “View Review Basis” control in the first predetermined area 605, the target issue introduction “Negative Guidance for Juveniles” and the target review basis “Descriptions or promotion of the following behaviors exists in the content . . . ” will be displayed in a pop-up window, and the display effect of which is shown in the pop-up window 504 in FIG. 5.

On the basis of the above embodiment, after displaying a target issue introduction and a target review basis corresponding to the to-be-modified target text segment in a predetermined display mode in the review result page, the method for displaying review information further comprises in response to a third trigger operation on a further to-be-modified text segment, displaying a further issue introduction and a further review basis corresponding to the further to-be-modified text segment in the first predetermined area to overlay the target issue introduction and the target review basis.

The further to-be-modified text segment herein is a to-be-modified text segment in the reviewed text that is different from the to-be-modified target text segment.

Specifically, according to the above description, since a display area of the first predetermined area is small, it may not be able to display detailed review results of a plurality of to-be-modified text segments at the same time. Based on this, after the user triggers the further to-be-modified text segment, an issue introduction (i.e., the further issue introduction) and a review basis (i.e., the further review basis) corresponding to the further to-be-modified text segment can be displayed in the first predetermined area to overlay the originally displayed target issue introduction and target review basis.

In some embodiments, when there are both the typo issue and the violation issue in the to-be-modified target text segment, based on the description of the priorities of the above two types of issues, after the user performs a first trigger operation on the to-be-modified target text segment, a violation issue introduction and a violation review basis of the violation issue corresponding to the to-be-modified target text segment are displayed in the review result page in a predetermined display mode.

Specifically, because of the high priority of the violation issue, after the user triggers the to-be-modified target text segment 202 in FIG. 2, a issue introduction (i.e. the violation issue introduction) and a review basis (i.e. the violation review basis) corresponding to the violation issue in the to-be-modified target text segment are directly displayed, the display effect of which can be shown in FIGS. 3-6. The target issue introduction in FIGS. 3-6 is the violation issue introduction, and the target review basis is the violation review basis.

Further, on the basis of the above embodiment, after the violation issue introduction and violation review basis are displayed, if a correction operation of the user eliminates the violation issue of the to-be-modified target text segment and the corresponding typo issue still exists, the detailed review result corresponding to the typo issue will be triggered for display. This can avoid the first display style of the to-be-modified target text segment from being converted to the second display style after the user corrects the typo issue first, and thereby can avoid the user from missing the modification to the corresponding violation issue.

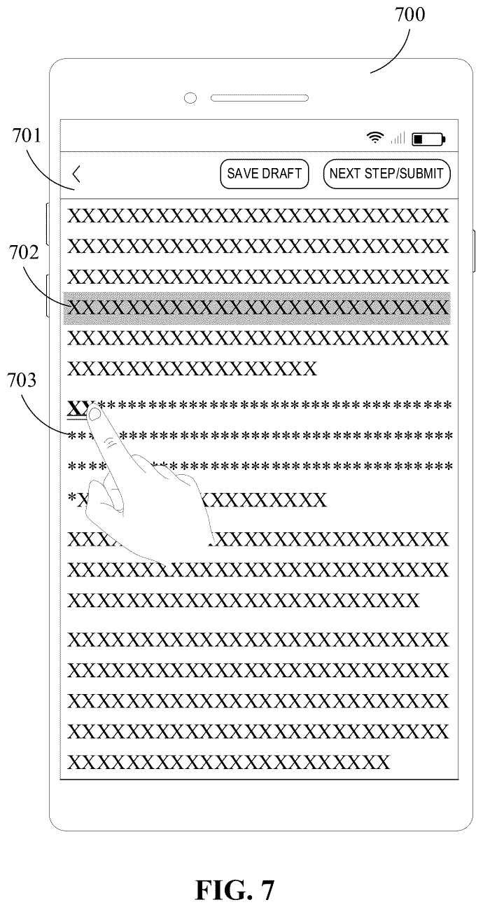

Specifically, if the user corrects the to-be-modified target text segment, the device for displaying review information will receive the corrected text segment input by the user. Then, the corrected text segment will be sent to a review server side. The review server side will replace the to-be-modified target text segment with the corrected text segment and review whether the corrected text segment is approved in the review. If it is not approved in the review, a prompt of the disapproval will be fed back to the device for displaying review information, so that the user can continue to modify. If the corrected text segment is approved in the review, the review server side will send a prompt of the approval to the device for displaying review information. The device for displaying review information will replace the to-be-modified target text segment with the corrected text segment and display the corrected text segment in the second display style, the display effect of which is shown in FIG. 7.

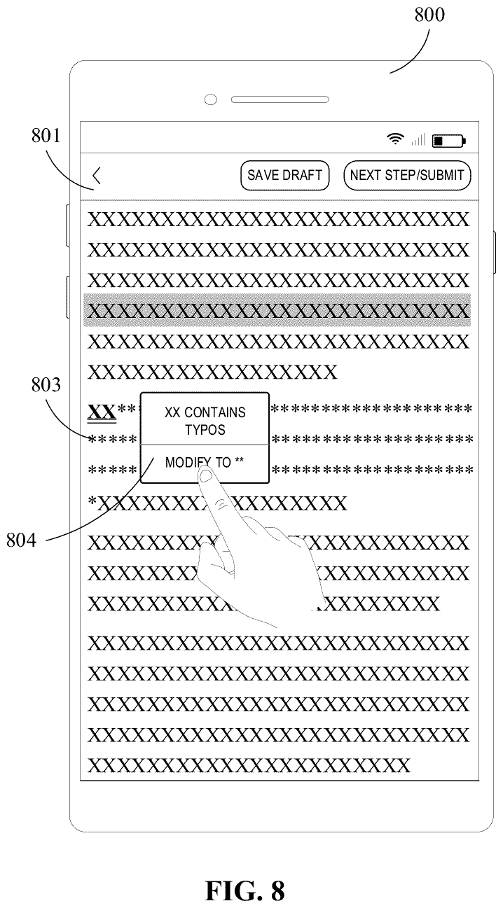

A device 700 for displaying review information in FIG. 7 displays a review result page 701. In addition to a to-be-modified text segment 702, a corrected text segment 703 is displayed in the review result page 701. As shown in FIG. 7, although the corrected text segment 703 eliminates the violation issue, it still has the typo issue corresponding to the to-be-modified target text segment (as shown in bold and underlined in FIG. 7). At this time, if the user performs a first trigger operation on the corrected text segment 703, the device 700 for displaying review information will display an issue introduction (i.e. a typo issue introduction) and a review basis (i.e. a typo review basis) corresponding to the corrected text segment 703 in a predetermined display mode, the display effect of which is shown in FIG. 8.

In FIG. 8, the device 800 for displaying review information displays a review result page 801, and a pop-up window 804 corresponding to a corrected text segment 803 is displayed in the review result page 801. The pop-up window 804 displays a typo issue introduction “XX contains typos” and a typo correction basis “modify to **”. The typo correction basis is also a modification suggestion for the typo “XX”, which can be provided as an interactive control. When the user triggers the interactive control, the “XX” can be replaced with “**” for modification.

In some embodiments, a violation issue corresponding to the modified target text segment and the number of issues corresponding to the violation issue are displayed in a second predetermined area in the review result page. A display position of the second predetermined area can be predetermined based on the size of the display screen and display content of the review result page. The display position of the second predetermined area remains fixed after predetermined, and if a text output window pops up, the text output window may overlay with the second predetermined area. In addition, if all violation issues are corrected, the second predetermined area will be hidden.

As shown in FIG. 2, a second predetermined area 205 can be the bottom area of the review result page 201. A banner control is displayed in the second predetermined area 205, which displays the violation issue and its number of issues, that is, “there are 10 violation issues in total”, and displays a prompt message “View” of the banner control additionally, which can be operably interacted with. It should be noted that the typo issue and its number of issues “12” can also be displayed in the top area 204 of the review result page.

Further, on the basis of the above embodiment, in response to a fourth triggering operation on the second predetermined area, the second predetermined area is hidden from the review result page, and the violation issue, the number of issues corresponding to the violation issue, a review basis viewing control and first issue records corresponding to the respective to-be-modified text segments are displayed in a third predetermined area corresponding to the second predetermined area. This allows the user to view all the to-be-modified text segments and their corresponding detailed review results to avoid omission.

The third predetermined area herein is also a predetermined fixed display area, its display position being the same as that of the second predetermined area. Because the third predetermined area displays detailed review results of a plurality of to-be-modified text segments, a display size of the third predetermined area is larger than that of the second predetermined area.

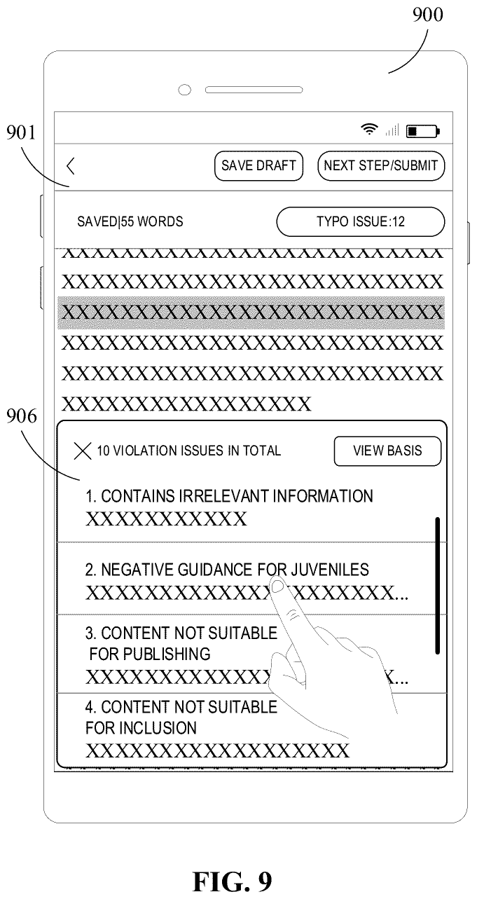

Specifically, if the user performs a triggering operation on the second predetermined area 205 in FIG. 2, the device for displaying review information can detect a corresponding fourth triggering operation and present the display effect of the review result page as shown in FIG. 9 in response to the fourth triggering operation. As shown in FIG. 9, a third predetermined area 906 is used instead of the second predetermined area in a review result page 901 of a device 900 for displaying review information. The third predetermined area 906 displays the violation issues and the number of issues corresponding to the violation issues, that is, “10 violation issues in total”, and displays a viewing control “Review Basis” for the review basis and the first issue records corresponding to the respective to-be-modified text segments additionally. Each of the first issue records contains at least a to-be-modified text segment and its corresponding issue introduction, and each of the first issue records is numbered and displayed based on the order in which the corresponding to-be-modified text segment appears in the reviewed text. If the third predetermined area 906 cannot display all the first issue records, a scrolling function can be provided for it so that the user can slide a scroll bar to view respective first issue records that are not being displayed.

Optionally, based on the above embodiment, in response to a sixth trigger operation on the review basis viewing control, a review basis corresponding to each of the first issue records is displayed in the third predetermined area to overlay the respective first issue record. That is, after the user triggers the review basis viewing control “Review Basis” in the third predetermined area 906, the review basis of the lowest level corresponding to each of the first issue records is displayed in the third predetermined area 906, and these review basis are displayed in the numbered order of the first issue records. Limited by the display size of the third predetermined area 906, only a part of the review basis of the lowest level can be displayed, and interactive functions can be provided for it. When the user triggers a certain review basis, the complete content of the review basis is displayed in the third predetermined area 906, and a return control is provided so that the user can operate to return to display all the review bases.

Alternatively, based on the above embodiments, in response to a fifth trigger operation on a target first issue record of the respective first issue records, the third predetermined area is hidden, and the second predetermined area is redisplayed. Further, a pop-up window is created at the to-be-modified text segment corresponding to the target first issue record, and the issue introduction in the target first issue record and a review basis corresponding to the respective issue introduction are displayed in the pop-up window.

Specifically, if the user triggers one of the first issue records (i.e., the target first issue record) in the third predetermined area 906 in FIG. 9, the display effect is shown in FIG. 3 or FIGS. 4-5. Taking FIG. 3 as an example, the third predetermined area is hidden in the review result page 301, and the second predetermined area 305 and its contents are redisplayed. At the same time, the pop-up window 304 is displayed in the surrounding area of the to-be-modified target text segment 302 corresponding to the target first issue record, and the target issue introduction and target review basis are displayed in the pop-up window 304.

It should be understood that when the fifth trigger operation performed by the user on the target first issue record is detected, the issue introduction in the target first issue record and the corresponding review basis corresponding to the respective issue introduction can also be displayed in the third predetermined area 906.

In another embodiment provided in the present disclosure, in accordance with a determination that the method for displaying review information may be implemented at a desktop PC client, the method for displaying review information is applied to a terminal on which the desktop client is installed, such as a laptop, a desktop computer.

In some embodiments, a typo issue and the number of typos of the typo issue are displayed in a fourth predetermined area of the review result page, and a violation issue, the number of issues of the violation issue and a review basis viewing control are displayed in a fifth predetermined area.

The fourth predetermined area and the fifth predetermined area herein are both predetermined display areas with fixed display positions.

Optionally, the fourth predetermined area and the fifth predetermined area are on the same side of the review result page. This makes it easy for users to view typo and violation issues uniformly.

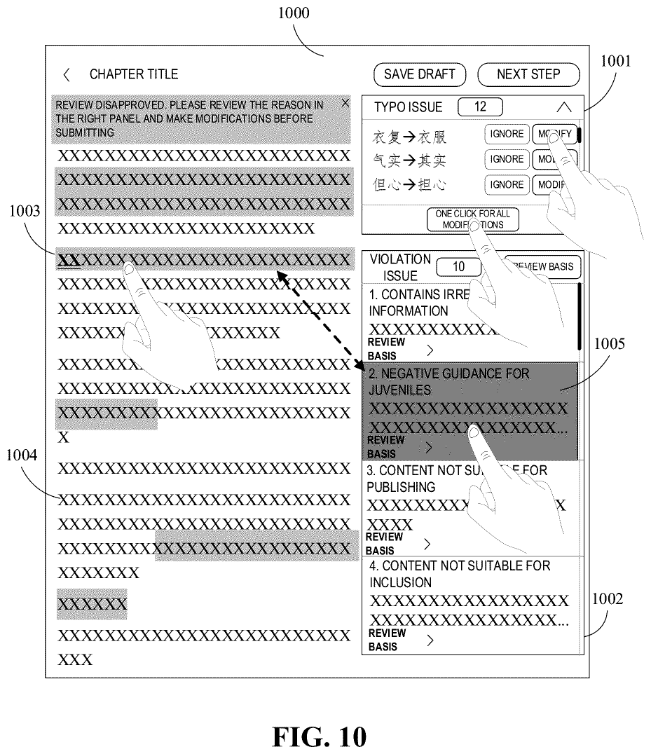

For example, a fourth predetermined area 1001 and a fifth predetermined area 1002 in a review result page 1000 in FIG. 10 are both predetermined on the right side of the review result page 1000, and the respective to-be-modified text segments 1003 and other text segments 1004 in the reviewed text have been displayed on the left side of the review result page 1000.

The fourth predetermined area 1001 displays the typo issue and the number of issues “12”. The fourth predetermined area 1001 can be in a display style with detailed content expanded as shown in FIG. 10, or in a display style with detailed content folded to display the above content.

The fifth predetermined area 1002 displays the violation issue, the number of issues “10” and a master viewing control “Review Basis” for viewing all review based. Similarly, the fifth predetermined area 1002 can be in the display style with the detailed content expanded as shown in FIG. 10, or in the display style with the detailed content folded to display the above content.

When the fourth predetermined area 1001 and the fifth predetermined area 1002 are displayed in the display style with the detailed content expanded, if they cannot display all detailed content, a scrolling to view function can be provided for them.

Furthermore, as shown in FIG. 10, the fourth predetermined area 1001 is located above the fifth predetermined area 1002, with the top position and display size of the fourth predetermined area 1001 fixed and the bottom position of the fifth predetermined area 1002 fixed. the display size of the fifth predetermined area 1002 changes with the number of issues corresponding to the violation issue and the display size of the fourth predetermined area 1001. This can display the detailed review results of the respective to-be-modified text segments more flexibly, improving user viewing efficiency.

In some embodiments, in response to the first trigger operation performed by the user on the to-be-modified target text segment, the target issue introduction and target review basis corresponding to the to-be-modified target text segment can be emphasized in the fifth predetermined area, in order to achieve the effect of reminding the user to view. Further, the user can trigger the display of detailed review results of the to-be-modified text segments and modify the to-be-modified text segments on demand, which is not limited by the order of the to-be-modified text segments.

In one example, in response to the first trigger operation performed by the user on the to-be-modified target text segment, a second issue record corresponding to the to-be-modified target text segment is highlighted and/or stuck on top in the fifth predetermined area.

The second issue records herein comprise the respective to-be-modified text segments, issue introductions corresponding to the to-be-modified text segments, and review basis viewing sub-controls.

Specifically, in accordance with a determination that second issue records corresponding to all the to-be-modified text segments are displayed in the fifth predetermined area, the device for displaying review information after the first trigger operation is detected, if the fifth predetermined area is in the display style with the detailed content expanded, then the second issue record corresponding to the to-be-modified target text segment is stuck to the top, or the second issue record is highlighted and stuck to the top; and if the fifth predetermined area is in the display style with the detailed content folded, then the fifth predetermined area is triggered to display in the display style with the detailed content folded first, and then the above second issue record is highlighted and/or stuck to the top.

It should be noted that according to the mapping relationship between the to-be-modified text segments, the issue introductions, and the review bases described above, the mapping relationship between the to-be-modified text segments and the second issue records can be pre-established in the device for displaying review information.

The fifth predetermined area 1002 being in the display style with the detailed content expanded and the hit second issue record being highlighted is taken as an example. Referring to FIG. 10, in the case where the fifth predetermined area 1002 is in the display style with the detailed content expanded, the detailed content displayed in the fifth predetermined area 1002 not only displays the content displayed when the detailed content is folded, but also displays the corresponding second issue records, which are numbered and displayed in the order that each to-be-modified text segment appears in the reviewed text. When the device for displaying review information detects the first trigger operation on the to-be-modified target text segment 1003, the second issue record corresponding to the to-be-modified target text segment is determined based on the mapping relationship between the above-mentioned to-be-modified text segments and the second issue records, and the second issue record 1005 corresponding to the to-be-modified target text segment 1003 is highlighted in the fifth predetermined area 1002 (as shown by the example of gray shading in FIG. 10).

In another example, in response to the first trigger operation performed by the user on the to-be-modified target text segment, the second issue record corresponding to the to-be-modified target text segment is added to the top or the end of the fifth predetermined area for display.

Specifically, in accordance with a determination that the second issue record corresponding to the to-be-modified text segment triggered by the user is displayed in the fifth predetermined area, the device for displaying review information after the first trigger operation is detected, can add the second issue record corresponding to the to-be-modified target text segment to the top or the end of the fifth predetermined area. If the fifth predetermined area is in the display style that the detailed content expanded, then the second issue record corresponding to the to-be-modified target text segment are add directly in the above method; and if the fifth predetermined area is the display style that the detailed content folded, the fifth predetermined area is triggered to display in the display style with the detailed content expanded first, and then the second issue record corresponding to the to-be-modified target text segment is added in the above method.

In other embodiments, in the case where the fifth predetermined area is in the display style with the detailed content expanded, in addition to the interactive operation that can trigger the to-be-modified text segment to highlight the second issue record, the user can quickly navigate to the to-be-modified text segment by triggering the second issue interactively, to further improve the viewing efficiency of the to-be-modified text segments and their detailed review results, which thereby further improves the modification efficiency and can avoid the user missing the to-be-modified text segments, to further improve the modification approval rate.

In one example, in response to a seventh trigger operation on the target second issue record of the respective second issue records, the to-be-modified text segment corresponding to the target second issue record is highlighted and flashed in the review result page.

Specifically, the device for displaying review information after a trigger operation (i.e., the seventh trigger operation) performed by the user on a certain second issue record (i.e., the target second issue record) is detected in the fifth predetermined area, determines the to-be-modified text segment corresponding to the target second issue record based on the mapping relationship between the to-be-modified text segments and the second issue records, and then highlights and flashes the to-be-modified text segment a certain number of times in the review result page to remind the user of the display position of the to-be-modified text segment.

In another example, in response to the seventh trigger operation, an association connection line between the target second issue record and the to-be-modified text segment corresponding to the target second issue record are displayed.

The association connection line herein refers to a connection line that displays the correspondence between the second issue record and the to-be-modified text segment. The display style of the association connection line is not limited.

Specifically, after the seventh trigger operation is detected and the to-be-modified text segment corresponding to the target second issue record is determined, the device for displaying review information displays the association connection line connecting the target second issue record and its corresponding to-be-modified text segment in the review result page to continuously indicate the correspondence between the two, making it easier for users to navigate to and view the to-be-modified text segment corresponding to the target second issue record.

As shown in FIG. 10, after the user triggers the target second issue record 1005, the association connection line between the target second issue record 1005 and the to-be-modified target text segment 1003 is displayed in the review result page 1000 (as shown by the double arrow dashed line in FIG. 10).

Based on the respective embodiments described above where the detailed content is expanded in the fifth predetermined area 1002, after the user triggers the review basis viewing sub-control, the review bases of the lowest level corresponding to the respective to-be-modified text segments can be displayed at the fifth predetermined area 1002 or at the pop-up window at the to-be-modified text segment corresponding to the review basis viewing sub-control. When the user triggers the master review control “Review Basis”, the review bases of the lowest level corresponding to the respective to-be-modified text segments can be displayed at the fifth predetermined area 1002 in the same numbering order.

In some embodiments, the fourth predetermined area 1001 may be in the style with the details expanded as shown in FIG. 10, which displays the detailed content including typos and their review bases (i.e., corrected words that are recommended for modification), a rejecting modification control “ignore”, an accepting modification control “modify” and a “one click for all modifications” control that quickly modifies all typos among typo correction controls. The above typos, corrected words, rejecting modification control “ignore” and accepting modification control “modify” may be collectively referred to as one typo issue item.

Alternatively, based on the above embodiment, the method for displaying review information further comprises in response to an eighth trigger operation on the typo correction control, replacing the typos in each of the to-be-modified text segments with the corresponding corrected words, displaying the number of the typos as zero in the fourth predetermined area, and hiding the respective typos, the corresponding corrected words and the typo correction control from the fourth predetermined area.

Specifically, the present disclosure provides an automatic correction function for the typo issue. As shown in FIG. 10, after the user triggers the “one click for all modifications” control in the fourth predetermined area 1001, the device for displaying review information will replace the respective typos with the corrected word corresponding to each of the typos and then display the fourth predetermined area in a display mode with detailed content hidden, that is, when there is no typo issue, the detailed display content of the fourth predetermined area is empty, with the corresponding display area hidden, and the typo issue and its number of issues“0” being displayed.

If the user only triggers the accepting modification control “modification” of a certain typo in the fourth predetermined area 1001, the device for displaying review information only replaces that typo, hides the typo issue item corresponding to that typo in the fourth predetermined area, and reduces the number of typo issues by 1.

In some embodiments, when there are both the violation issue and the typo issue in the to-be-modified target text segment, the same as the descriptions of the above-described embodiment of the mobile terminal, after the user triggers the to-be-modified target text segment, the detailed review results corresponding to the violation issue will be display first in the way as described in the above embodiments, i.e., the second issue record corresponding to the to-be-modified target text segment is displayed in the fifth predetermined area in at least one display style of highlighting, sticking on the top and adding.

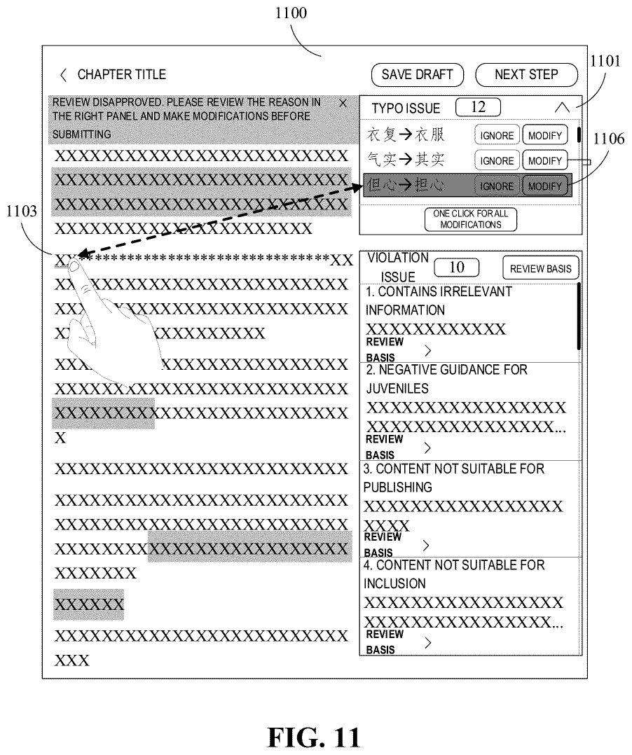

Optionally, after the user corrects the violation issue of the to-be-modified target text segment, as shown in FIG. 11, a to-be-modified target text segment is replaced with a corrected text segment 1103 in a review result page 1100. The corrected text segment 1103 still has the typo issue. At this time, if the user continues to trigger the corrected text segment 1103, it will trigger that a typo issue item 1106 where a typo issue introduction corresponding to the corrected text segment 1103 and a typo review basis are located is emphasized by highlighting and/or sticking on the top in the fourth predetermined area 1101. The highlighted example in FIG. 11 is a gray shading.

Optionally, after the user triggers the typo issue item 1106 in the fourth predetermined area 1101, the corrected text segment 1103 can also be highlighted and flashed, or the association connection line between the corrected text segment 1103 and the typo issue item 1106 can be displayed (as shown in FIG. 11 with a double arrow dashed line).

In summary, the method for displaying review information provided by the above embodiments provides more detailed and accurate review information (i.e., the mapping relationship between the to-be-modified text segments, the issue introductions and the review bases), which not only can improve the amount of information of the review information display, thereby improving the efficiency of users to view and modify, but also can provide a large number of accurate training samples for subsequent optimization of online review algorithm, reducing the workload and difficulty of review algorithm training.

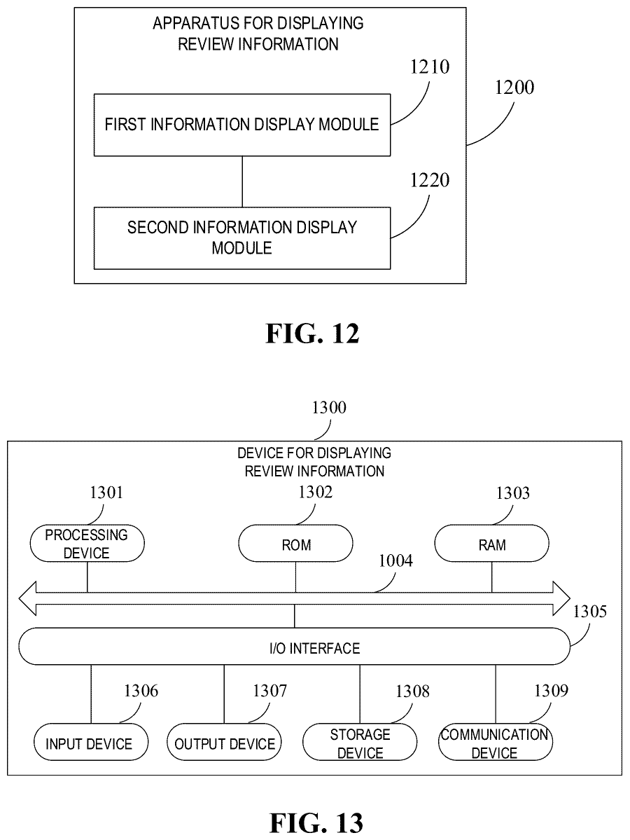

FIG. 12 shows a schematic diagram of a structure of an apparatus for displaying review information provided in an embodiment of the present disclosure. As shown in FIG. 12, a device 1200 for displaying review information may include: a first information display module 1210 configured to display to-be-modified text segments of a reviewed text in a first display style in a review result page, and displaying text segments of the reviewed text other than the to-be-modified text segments in a second display style; and a second information display module 1220 configured to display, in response to a first trigger operation on a to-be-modified target text segment of the respective to-be-modified text segments, a target issue introduction and a target review basis corresponding to the to-be-modified target text segment in a predetermined display mode in the review result page.

The above-mentioned apparatus for displaying review information can display to-be-modified text segments of a reviewed text in a first display style in a review result page, and display text segments of the reviewed text other than the to-be-modified text segments in a second display style. The to-be-modified text segments can be highlighted thereby, so that a user can view text content that has not been approved more quickly. And in response to a first trigger operation on a to-be-modified target text segment of the respective to-be-modified text segments, a target issue introduction and a target review basis corresponding to the to-be-modified target text segment are displayed in a predetermined display mode in the review result page, so that the position of the to-be-modified target text segment triggered by the user is determined quickly. At the same time, the target issue introduction and its corresponding target review basis of the to-be-modified target text segment that has not been approved are displayed in detail, so that the user can quickly and clearly know the issues existing in the to-be-modified target text segment and the corresponding modification suggestions, improving the amount and transparency of information displayed in the review result, thereby improving modification efficiency and modification approval rate of the to-be-modified text segments.

In some embodiments, issue types corresponding to the respective to-be-modified text segments and the number of issues for each of the issue types are displayed in the review result page additionally.

In some embodiments, review bases comprise a review basis of a highest level, a review basis of a middle level, and a review basis of a lowest level; the target review basis is a review basis of a lowest level corresponding to the to-be-modified target text segment; and after displaying a target issue introduction and a target review basis corresponding to the to-be-modified target text segment in a predetermined display mode in the review result page, the method further comprises: in response to a second trigger operation of a user, displaying the review basis of the middle level and/or the review basis of the highest level corresponding to the target review basis in the review result page.

In some embodiments, the issue types comprise a typo issue and a violation issue that violates a review basis, and a priority of the violation issue is higher than that of the typo issue; and accordingly, the second information display module 1220 is specifically configured to in accordance with a determination that the to-be-modified target text segment has the typo issue and the violation issue, display a violation issue introduction and a violation review basis of the violation issue corresponding to the to-be-modified target text segment in the predetermined display mode in the review result page.

Further, the second information display module 1220 is further configured to after displaying a violation issue introduction and a violation review basis of the violation issue corresponding to the to-be-modified target text segment in the predetermined display mode in the review result page, receive a corrected text segment corresponding to the to-be-modified target text segment, and send the corrected text segment to a review server side; and in accordance with a determination that a feedback response of the corrected text segment eliminating the violation issue is received from the review server side, replace the target corrected text segment with the corrected text segment in the review result page, and display the corrected text segment in the second display style, and in accordance with a determination that the corrected text segment has the typo issue corresponding to the to-be-modified target text segment, display a typo issue introduction and a typo review basis of the typo issue corresponding to the corrected text segment in the predetermined display mode.

In one embodiment provided in the present disclosure, the apparatus 1200 for displaying review information is configured in a terminal corresponding to a mobile client.

In some embodiments of the above embodiments, the second information display module 1220 is specifically configured to create a pop-up window in the review result page, and display the target issue introduction and the target review basis in the pop-up window.

In other embodiments of the above embodiments, the second information display module 1220 is specifically configured to display the target issue introduction and the target review basis in a first predetermined area of the review result page.

Furthermore, the apparatus 1200 for displaying review information further includes a third information display module configured to after displaying a target issue introduction and a target review basis corresponding to the to-be-modified target text segment in a predetermined display mode in the review result page, in response to a third trigger operation on a further to-be-modified text segment, display a further issue introduction and a further review basis corresponding to the further to-be-modified text segment in the first predetermined area to overlay the target issue introduction and the target review basis; wherein the further to-be-modified text segment is a to-be-modified text segment in the reviewed text that is different from the to-be-modified target text segment.

In some embodiments of the above embodiments, a violation issue corresponding to the modified target text segment and the number of issues corresponding to the violation issue are displayed in a second predetermined area in the review result page; accordingly, the apparatus 1200 for displaying review information further includes a fourth information display module configured to in response to a fourth triggering operation on the second predetermined area, hide the second predetermined area from the review result page, and display the violation issue, the number of issues corresponding to the violation issue, a review basis viewing control and first issue records corresponding to the respective to-be-modified text segments in a third predetermined area corresponding to the second predetermined area; wherein the first issue records comprise issue introductions corresponding to the to-be-modified text segments and the to-be-modified text segments.

Further, the apparatus 1200 for displaying review information further includes a fifth information display module configured to after in response to a fourth triggering operation on the second predetermined area, the second predetermined area is hidden from the review result page, and the violation issue, the number of issues corresponding to the violation issue, a review basis viewing control and first issue records corresponding to the respective to-be-modified text segments are displayed in a third predetermined area corresponding to the second predetermined area, in response to a fifth trigger operation on a target first issue record of the respective first issue records, hide the third predetermined area, redisplay the second predetermined area, create a pop-up window at the to-be-modified text segment corresponding to the target first issue record, and display the issue introduction in the target first issue record and a review basis corresponding to the respective issue introduction in the pop-up window.

Optionally, the apparatus 1200 for displaying review information further includes a sixth information display module configured to after in response to a fourth triggering operation on the second predetermined area, the second predetermined area is hidden from the review result page, and the violation issue, the number of issues corresponding to the violation issue, a review basis viewing control and first issue records corresponding to the respective to-be-modified text segments are displayed in a third predetermined area corresponding to the second predetermined area, in response to a sixth trigger operation on the review basis viewing control, display a review basis corresponding to each of the first issue records in the third predetermined area to overlay the respective first issue record.

In some embodiments of the above embodiments, in accordance with a determination that a display position of the pop-up window at least partially overlaps with a display position of a text input window, the display position of the pop-up window is moved until there is no overlap between the display position of the pop-up window and the display position of the text input window.

In another embodiment provided in the present disclosure, the apparatus 1200 for displaying review information is configured in a terminal corresponding to a desktop client; and accordingly, a typo issue and the number of typos of the typo issue are displayed in a fourth predetermined area of the review result page, and a violation issue, the number of issues of the violation issue and a review basis viewing control are displayed in a fifth predetermined area.

In some embodiments of the above embodiments, the second information display module 1220 is specifically configured to in accordance with a determination that second issue records corresponding to the respective to-be-modified text segments are additionally displayed in the fifth predetermined area, and in response to the first trigger operation, highlight and/or stick on top the second issue record corresponding to the to-be-modified target text segment in the fifth predetermined area; wherein the second issue records comprise issue introductions corresponding to the to-be-modified text segments, the respective to-be-modified text segments, and review basis viewing sub-controls, and a review basis corresponding to the corresponding to-be-modified target text segment is displayed after a review basis viewing sub-control is triggered; or in accordance with a determination that the second issue record corresponding to a to-be-modified text segment that has been triggered is additionally displayed in the fifth predetermined area, and in response to the first trigger operation, add the second issue record corresponding to the to-be-modified target text segment to the top or the end of the fifth predetermined area for display.

In some embodiments of the above embodiments, the apparatus 1200 for displaying review information further includes a seventh information display module configured to in response to a seventh triggering operation on a target second issue record of the respective second issue records, highlight and flash the to-be-modified text segment in the reviewed text corresponding to the target second issue record in the review result page; or in response to the seventh trigger operation, display an association connection line between the target second issue record and the to-be-modified text segment corresponding to the target second issue record.

In some embodiments of the above embodiments, e respective typos, corrected words corresponding to the respective typos and a typo correction control are further displayed in the fourth predetermined area; accordingly, the apparatus 1200 for displaying review information further includes an eighth information display module configured to in response to an eighth trigger operation on the typo correction control, replacing the typos in each of the to-be-modified text segments with the corresponding corrected words, displaying the number of the typos as zero in the fourth predetermined area, and hiding the respective typos, the corresponding corrected words and the typo correction control from the fourth predetermined area.

In some embodiments of the above embodiments, the fourth predetermined area and the fifth predetermined area are on a same side in the review result page; and the fourth predetermined area is located above the fifth predetermined area, with a top of the fourth predetermined area fixed and a bottom of the fifth predetermined area fixed.

It should be noted that the apparatus 1200 for displaying review information shown in FIG. 12 may perform the various steps of the method embodiments shown in FIGS. 1-11, and to achieve the various processes and effects of the method embodiments shown in FIGS. 1-11, which will not be repeated herein.

The present disclosure further provides a device for displaying review information, which may include a processor and a memory. The memory may be used to store executable instructions. The processor herein may be used to read executable instructions from the memory, and executes the executable instructions to implement the method for displaying review information according to any embodiment of the present disclosure.

FIG. 13 shows a schematic diagram of a structure of a device for displaying review information provided by the present disclosure. The device 1300 for displaying review information shown in FIG. 13 is only an example and should not bring any limitation on the functionality and scope of use of embodiments of the present disclosure.

Below with specific reference to FIG. 13, which shows a schematic diagram of the structure suitable for implementing the device 1300 for displaying review information in the embodiments of the present disclosure.

As shown in FIG. 13, the device 1300 for displaying review information may include processing devices (such as Central Processor, Graphics Processing Unit, etc.) 1301, which can perform various appropriate actions and processes based on programs stored in read-only memory (ROM) 1302 or loaded from storage device 1308 into random access memory (RAM) 1303. In RAM 1303, various programs and data required for the operation of information processing device 1300 are also stored. Processing devices 1301, ROM 1302, and RAM 1303 are connected to each other through bus 1304. Input/output interface (I/O interface) 1305 is also connected to bus 1304.

Typically, the following devices can be connected to the I/O interface 1305: input devices 1306 including touch screens, touchpads, keyboards, mice, cameras, microphones, accelerometers, gyroscopes, etc.; output devices 1307 including liquid crystal displays (LCDs), speakers, vibrators, etc.; storage devices 1308 including magnetic tapes, hard disks, etc.; and communication devices 1309. Communication devices 1309 can allow the device 1300 for displaying review information to communicate wirelessly or wirelessly with other devices to exchange data. Although FIG. 13 shows the device 1300 for displaying review information with various devices, it should be understood that it is not required to implement or have all of the illustrated devices. More or fewer devices can be implemented or provided instead.

The present disclosure further provides a computer-readable storage medium, the storage medium stores a computer program, when executed by a processor, causes the processor to implement the method for displaying review information according to any embodiment of the present disclosure.

In particular, according to embodiments of the present disclosure, the process described above with reference to the flowchart may be implemented as a computer software program. For example, embodiments of the present disclosure include a computer program product comprising a computer program carried on a non-transitory computer-readable medium, the computer program comprising program code for performing the method shown in the flowchart. In such embodiments, the computer program may be downloaded and installed from the network through the communication device 1309, or installed from the storage device 1308, or installed from the ROM 1302. When the computer program is executed by the processing device 1301, the above-described functions predetermined in the method for displaying review information of the present disclosure are performed.

It should be noted that the computer-readable medium described above in the present disclosure can be a computer-readable signal medium or a computer-readable storage medium or any combination thereof. The computer-readable storage medium can be, for example, but not limited to, an electrical, magnetic, optical, electromagnetic, infrared, or semiconductor system, apparatus or device, or any combination thereof. More specific examples of computer-readable storage media can include but are not limited to: an electrical connection with one or more wires, a portable computer disk, a hard disk, random access memory (RAM), read-only memory (ROM), erasable programmable read-only memory (EPROM or flash memory), optical fibers, portable compact disk read-only memory (CD-ROM), optical storage devices, magnetic storage devices, or any suitable combination thereof. In the present disclosure, a computer-readable storage medium can be any tangible medium containing or storing a program that can be used by or in conjunction with an instruction execution system, apparatus, or device. In the present disclosure, a computer-readable signal medium can include a data signal propagated in a baseband or as part of a carrier wave, which carries computer-readable program code. Such propagated data signals can take many forms, including but not limited to electromagnetic signals, optical signals, or any suitable combination thereof. Computer-readable signal media can also be any computer-readable medium other than computer-readable storage media, which can send, propagate, or transmit programs for use by or in conjunction with instruction execution systems, devices, or devices. The program code contained on the computer-readable medium can be transmitted using any suitable medium, including but not limited to: wires, optical cables, RF (radio frequency), etc., or any suitable combination thereof.

In some embodiments, the client, server may communicate using any currently known or future developed network protocol such as HTTP, and may be interconnected with any form or medium of digital data communication (e.g., a communication network). Examples of communication networks include local area networks (“LANs”), wide area networks (“WANs”), the Internet (e.g., the Internet), and end-to-end networks (e.g., ad hoc end-to-end networks), as well as any currently known or future developed networks.

The computer-readable medium can be included in the device for displaying review information, or it can exist alone and not be assembled into the device for displaying review information.

The computer-readable medium carries one or more programs, when executed by the apparatus for displaying review information, causes the apparatus for displaying review information performs the steps of the method for displaying review information according to any embodiment of the present disclosure.

In the embodiments of the present disclosure, it may be one or more programming languages or combinations thereof to write computer program code for performing the operations of the present disclosure, the above-described programming languages include, but are not limited to Object Oriented programming languages—such as Java, Smalltalk, C++, further comprising conventional procedural programming languages—such as “C” language or similar programming languages. The program code may be executed entirely on the user's computer, partially executed on the user's computer, executed as a separate software package, partially executed on the user's computer on a remote computer, or entirely on a remote computer or server. In the case involving a remote computer, the remote computer may be any kind of network—including a local area network (LAN) or a wide area network (WAN)—connected to the user's computer, or may be connected to an external computer (e.g., using an Internet service provider to connect via the Internet).

The flowcharts and block diagrams in the accompanying drawings illustrate the architecture, functions, and operations of the devices, methods, and computer program products that may be implemented in accordance with various embodiments of the present disclosure. In this regard, each block in the flowcharts or block diagrams may represent a module, program segment, or portion of code that contains one or more executable instructions for implementing a specified logical function. It should also be noted that in some alternative implementations, the functions marked in the blocks may also occur in a different order than those marked in the figures. For example, two blocks represented in succession may actually be executed substantially in parallel, and they may sometimes be executed in reverse order, depending on the functions involved. It should also be noted that each block in the block diagrams and/or flowcharts, as well as combinations of blocks in the block diagrams and/or flowcharts, may be implemented using a dedicated hardware-based system that performs the specified functions or operations, or may be implemented using a combination of dedicated hardware and computer instructions.

Described in the present embodiment relates to the disclosed unit may be implemented by way of software, may be implemented by way of hardware, wherein the name of the unit does not constitute a limitation on the unit itself in some cases.

The functions described above herein may be performed at least in part by one or more hardware logic components. For example, without limitation, example types of hardware logic components that may be used include: field programmable gate arrays (FPGAs), application specific integrated circuits (ASICs), application specific standard products (ASSPs), system-on-chip (SOCs), complex programmable logic devices (CPLDs), and the like.

In the context of the present disclosure, machine-readable media can be tangible media that can contain or store programs for use by or in conjunction with instruction execution systems, apparatuses, or devices. Machine-readable media can be machine-readable signal media or machine-readable storage media. Machine-readable media can include, but are not limited to, electronic, magnetic, optical, electromagnetic, infrared, or semiconductor systems, devices, or devices, or any suitable combination thereof. More specific examples of machine-readable storage media may include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination thereof.

The above description is only the preferred embodiment of the present disclosure and an explanation of the technical principles used. Those skilled in the art should understand that the scope of the disclosure involved in the present disclosure is not limited to the specific combination of the technical features of the above technical solutions, but should also cover other technical solutions formed by any combination of the above technical features or equivalent features without departing from the above disclosure concept. For example, the technical solutions formed by replacing the above features with (but not limited to) technical features with similar functions disclosed in the present disclosure.

In addition, although the operations are depicted in a specific order, this should not be understood as requiring these operations to be performed in the specific order shown or in sequential order. Under certain circumstances, multitasking and parallel processing may be advantageous. Similarly, although several specific implementation details are included in the above discussion, these should not be construed as limiting the scope of the present disclosure. Certain features described in the context of individual embodiments may also be implemented in combination in a single embodiment. Conversely, various features described in the context of a single embodiment may also be implemented in a plurality of embodiments individually or in any suitable sub-combination.

While the subject matter has been described in language specific to structural features and/or methodological logical acts, it should be understood that the subject matter predetermined in the appended claims is not necessarily limited to the particular features or acts described above. Rather, the particular features and acts described above are merely example forms of implementation of the claims.

What is claimed is:

1. A method for displaying review information, comprising:
displaying to-be-modified text segments of a reviewed text in a first display style in a review result page, and displaying text segments of the reviewed text other than the to-be-modified text segments in a second display style; and
in response to a first trigger operation on a to-be-modified target text segment of the respective to-be-modified text segments, displaying a target issue introduction and a target review basis corresponding to the to-be-modified target text segment in a predetermined display mode in the review result page.

2. The method of claim 1, wherein issue types corresponding to the respective to-be-modified text segments and the number of issues for each of the issue types are displayed in the review result page additionally.

3. The method of claim 1, wherein review bases comprise a review basis of a highest level, a review basis of a middle level, and a review basis of a lowest level;
wherein the target review basis is a review basis of a lowest level corresponding to the to-be-modified target text segment; and
wherein after displaying a target issue introduction and a target review basis corresponding to the to-be-modified target text segment in a predetermined display mode in the review result page, the method further comprises:
in response to a second trigger operation of a user, displaying the review basis of the middle level and/or the review basis of the highest level corresponding to the target review basis in the review result page.

4. The method of claim 2, wherein the issue types comprise a typo issue and a violation issue that violates a review basis, and a priority of the violation issue is higher than that of the typo issue; and
in accordance with a determination that the to-be-modified target text segment has the typo issue and the violation issue, the displaying a target issue introduction and a target review basis corresponding to the to-be-modified target text segment in a predetermined display mode in the review result page comprises:
displaying a violation issue introduction and a violation review basis of the violation issue corresponding to the to-be-modified target text segment in the predetermined display mode in the review result page.

5. The method of claim 4, wherein after displaying a violation issue introduction and a violation review basis of the violation issue corresponding to the to-be-modified target text segment in the predetermined display mode in the review result page, the method further comprises:
receiving a corrected text segment corresponding to the to-be-modified target text segment, and sending the corrected text segment to a review server side; and
in accordance with a determination that a feedback response of the corrected text segment eliminating the violation issue is received from the review server side, replacing the to-be-modified target text segment with the corrected text segment in the review result page, and displaying the corrected text segment in the second display style, and
in accordance with a determination that the corrected text segment has the typo issue corresponding to the to-be-modified target text segment, displaying a typo issue introduction and a typo review basis of the typo issue corresponding to the corrected text segment in the predetermined display mode.

6. The method of claim 1, wherein in accordance with a determination that the method is implemented at a mobile client, the displaying a target issue introduction and a target review basis corresponding to the to-be-modified target text segment in a predetermined display mode in the review result page comprises:
creating a pop-up window in the review result page, and displaying the target issue introduction and the target review basis in the pop-up window.

7. The method of claim 1, wherein in accordance with a determination that the method is applied to a mobile client, the displaying a target issue introduction and a target review basis corresponding to the to-be-modified target text segment in a predetermined display mode in the review result page comprises:
displaying the target issue introduction and the target review basis in a first predetermined area of the review result page; and/or
after displaying a target issue introduction and a target review basis corresponding to the to-be-modified target text segment in a predetermined display mode in the review result page, the method further comprises:
in response to a third trigger operation on a further to-be-modified text segment, displaying a further issue introduction and a further review basis corresponding to the further to-be-modified text segment in the first predetermined area to overlay the target issue introduction and the target review basis;
wherein the further to-be-modified text segment is a to-be-modified text segment in the reviewed text that is different from the to-be-modified target text segment.

8. The method of claim 1, wherein in accordance with a determination that the method is applied to a mobile client, a violation issue corresponding to the to-be-modified text segments and the number of issues corresponding to the violation issue are displayed in a second predetermined area in the review result page; and
in response to a fourth triggering operation on the second predetermined area, the second predetermined area is hidden from the review result page, and the violation issue, the number of issues corresponding to the violation issue, a review basis viewing control and first issue records corresponding to the respective to-be-modified text segments are displayed in a third predetermined area corresponding to the second predetermined area;
wherein the first issue records comprise issue introductions corresponding to the to-be-modified text segments and the to-be-modified text segments.

9. The method of claim 8, wherein after in response to a fourth triggering operation on the second predetermined area, the second predetermined area is hidden from the review result page, and the violation issue, the number of issues corresponding to the violation issue, a review basis viewing control and first issue records corresponding to the respective to-be-modified text segments are displayed in a third predetermined area corresponding to the second predetermined area, the method further comprises:
in response to a fifth trigger operation on a target first issue record of the respective first issue records, hiding the third predetermined area, redisplaying the second predetermined area, creating a pop-up window at the to-be-modified text segment corresponding to the target first issue record, and displaying the issue introduction in the target first issue record and a review basis corresponding to the respective issue introduction in the pop-up window.

10. The method of claim 8, wherein after in response to a fourth triggering operation on the second predetermined area, the second predetermined area is hidden from the review result page, and the violation issue, the number of issues corresponding to the violation issue, a review basis viewing control and first issue records corresponding to the respective to-be-modified text segments are displayed in a third predetermined area corresponding to the second predetermined area, the method further comprises:
in response to a sixth trigger operation on the review basis viewing control, displaying a review basis corresponding to each of the first issue records in the third predetermined area to overlay the respective first issue record.

11. The method of claim 6, wherein in accordance with a determination that a display position of the pop-up window at least partially overlaps with a display position of a text input window, the display position of the pop-up window is moved until there is no overlap between the display position of the pop-up window and the display position of the text input window.

12. The method of claim 1, wherein in accordance with a determination that the method is implemented at a desktop client, a typo issue and the number of typos of the typo issue are displayed in a fourth predetermined area of the review result page, and a violation issue, the number of issues of the violation issue and a review basis viewing control are displayed in a fifth predetermined area.

13. The method of claim 12, wherein in response to a first trigger operation on a to-be-modified target text segment of the respective to-be-modified text segments, displaying a target issue introduction and a target review basis corresponding to the to-be-modified target text segment in a predetermined display mode in the review result page comprises:
in accordance with a determination that second issue records corresponding to the respective to-be-modified text segments are additionally displayed in the fifth predetermined area, and in response to the first trigger operation, highlighting and/or sticking on top the second issue record corresponding to the to-be-modified target text segment in the fifth predetermined area;
wherein the second issue records comprise issue introductions corresponding to the to-be-modified text segments, the respective to-be-modified text segments, and review basis viewing sub-controls, and a review basis corresponding to the corresponding to-be-modified target text segment is displayed after a review basis viewing sub-control is triggered; or
in accordance with a determination that the second issue record corresponding to a to-be-modified text segment that has been triggered is additionally displayed in the fifth predetermined area, and in response to the first trigger operation, adding the second issue record corresponding to the to-be-modified target text segment to the top or the end of the fifth predetermined area for display.

14. The method of claim 13, wherein the method further comprises:
in response to a seventh triggering operation on a target second issue record of the respective second issue records, highlighting and flashing the to-be-modified text segment in the reviewed text corresponding to the target second issue record in the review result page; or
in response to the seventh trigger operation, displaying an association connection line between the target second issue record and the to-be-modified text segment corresponding to the target second issue record.

15. The method of claim 12, wherein respective typos, corrected words corresponding to the respective typos and a typo correction control are further displayed in the fourth predetermined area; and
wherein the method further comprises:
in response to an eighth trigger operation on the typo correction control, replacing the typos in each of the to-be-modified text segments with the corresponding corrected words, displaying the number of the typos as zero in the fourth predetermined area, and hiding the respective typos, the corresponding corrected words and the typo correction control from the fourth predetermined area.

16. The method of claim 12, wherein the fourth predetermined area and the fifth predetermined area are on a same side in the review result page; and
the fourth predetermined area is located above the fifth predetermined area, with a top of the fourth predetermined area fixed and a bottom of the fifth predetermined area fixed.

17-19. (canceled)

20. A device for displaying review information, comprising:
a processor; and
a memory for storing executable instructions,
wherein the processor is configured to read the executable instructions from the memory and execute the executable instructions to perform acts comprising:
displaying to-be-modified text segments of a reviewed text in a first display style in a review result page, and displaying text segments of the reviewed text other than the to-be-modified text segments in a second display style; and
in response to a first trigger operation on a to-be-modified target text segment of the respective to-be-modified text segments, displaying a target issue introduction and a target review basis corresponding to the to-be-modified target text segment in a predetermined display mode in the review result page.

21. The device of claim 20, wherein issue types corresponding to the respective to-be-modified text segments and the number of issues for each of the issue types are displayed in the review result page additionally.

22. The device of claim 20, wherein review bases comprise a review basis of a highest level, a review basis of a middle level, and a review basis of a lowest level;
wherein the target review basis is a review basis of a lowest level corresponding to the to-be-modified target text segment; and
wherein after displaying a target issue introduction and a target review basis corresponding to the to-be-modified target text segment in a predetermined display mode in the review result page, the acts further comprise:
in response to a second trigger operation of a user, displaying the review basis of the middle level and/or the review basis of the highest level corresponding to the target review basis in the review result page.

23. A non-transitory computer-readable storage medium, wherein the storage medium stores a computer program which, when executed by a processor, causes the processor to perform acts comprising:
displaying to-be-modified text segments of a reviewed text in a first display style in a review result page, and displaying text segments of the reviewed text other than the to-be-modified text segments in a second display style; and
in response to a first trigger operation on a to-be-modified target text segment of the respective to-be-modified text segments, displaying a target issue introduction and a target review basis corresponding to the to-be-modified target text segment in a predetermined display mode in the review result page.
